(19) United States
(12) Patent Application Publication
(10) Pub. No.: US 2004/0159026 A1
(43) Pub. Date: Aug. 19, 2004

(54) Display device and method

(75) Inventors: Allen N. Anderson, Frankfort, IL (US); Thomas Minard, Evergreen Park, IL (US)

Correspondence Address: SIDLEY AUSTIN BROWN & WOOD LLP, 717 NORTH HARWOOD, SUITE 3400, DALLAS, TX, 75201, US

(73) Assignee: WHITEHALL JEWELLERS, INC.

(21) Appl. No.: 10/366,757

(22) Filed: Feb. 14, 2003

(51) Int. Cl. G09F 7/04

(52) U.S. Cl. 40/600; 40/661.01

(57) ABSTRACT

The described embodiments of the present invention include a system and method for display. The display includes a mounting having a ferrous component, the mounting being adapted for the display of an item. The display system also includes a tag. The tag has a display surface for display of a desired message and has a magnet attached thereto. The magnet provides an attractive force to the ferrous component when the tag is placed on the mounting.

This abstract is provided for the sole purpose of complying with the rules requiring an abstract to allow a searcher or other reader to quickly ascertain the subject matter of the technical disclosure contained herein. This abstract is submitted with the express understanding that it will not be used to interpret or to limit the scope or the meaning of the claims.

### FIELD OF THE INVENTION

The present invention relates to the field of display systems for retails sales and the like. More specifically, the present invention relates to the field of merchandise display using magnetically adherent tagging.

### BACKGROUND OF THE INVENTION

The display of jewelry for retail presents many challenges. Because of its small size and delicacy, it is generally not desirable or feasible to provide a tag that directly adheres to the product. The tagging of jewelry is generally achieved in the industry in one of two ways.

The first method is small tags attached to a loop of string. The loop is tied to the merchandise, generally by threading a loop of the string through an opening in the jewelry and pulling the tag through the loop. Because this task is tedious, it is often avoided by staff and delays occur in pricing and promotions. In addition, the labor cost for setting and changing the tags is great, either in direct costs or time that sales staff are not spending with customers. An additional problem with tags is that it is difficult to maintain a neat, professional display because the tags hang loose from their item.

The second method uses tape to directly attach tags to the display. This provides a less than optimal appearance and may damage the displays, which are often covered in expensive, delicate materials. A tagging system that avoids string tags and taping is a significant step forward in the art.

Magnets have been used in display systems in the prior art for the display of jewelry. For example, Christman, U.S. Pat. No. 5,377,820 shows a system where magnetic display cards are use. Earrings are mounted to the display card and magnetic attraction holds the display cards to the display case. In Knox, U.S. Pat. No. 5,301,777, magnets are used in the display case itself to hold items that include ferrometalic components. However, the prior art does not provide a solution for the problem of providing easily changed tags for retail displays.

### SUMMARY

The described embodiments of the present invention include a system for display. The display includes a mounting having a ferrous component, the mounting being adapted for the display of an item. The display system also include a tag. The tag has a display surface for display of a desired message and has a magnet attached thereto. The magnet provides an attractive force to the ferrous component when the tag is placed on the mounting.

Another described embodiment of the present invention is also a display device. The display device includes a surface of the display device which has a ferrous component. Examples of the ferrous component are a dot of stainless steel and a substrate of stainless steel. The display device further includes a mounting. The mounting is adapted for the display of an item. The display devices also includes a tag. The tag has a display surface for display of a desired message and has a magnet attached thereto. The magnet provides an attractive force to the ferrous component when the tag is placed on the surface.

In another described embodiment of the present invention is a method for display of an item. A display is provided having a mounting including a ferrous component, the mounting being adapted for the display of the item. Also provided is a tag. The tag has a display surface for display of a desired message and has a magnet attached thereto. The magnet provides an attractive force to the ferrous component when the tag is placed on the mounting.

Yet another described embodiment of the present invention is also a method for display of an item. A display device is provided that includes a surface of the display device which has a ferrous component. Also provided is a mounting. The mounting is adapted for the display of the item. In addition, a tag is provided. The tag has a display surface for display of a desired message and has a magnet attached thereto. The magnet provides an attractive force to the ferrous component when the tag is placed on the surface.

### DESCRIPTION OF THE DRAWING

FIG. 1 is a perspective view of one embodiment of the present invention;

FIG. 2 is a side view of the display mounting of the embodiment of FIG. 1;

FIG. 3 is a perspective view of one version of the substrate of the display mounting of the embodiment of FIG. 1;

FIG. 4 is a perspective view of another version of the substrate of the display mounting of the embodiment of FIG. 1;

FIG. 5 is a perspective view of another embodiment of the present invention;

FIG. 6 is a perspective view of another embodiment of the present invention;

FIG. 7 is a perspective view of another embodiment of the present invention:

FIG. 8 is a frontal view of a sign system comprising another embodiment of the present invention;

FIG. 9 is a frontal view of a window display system comprising another embodiment of the present invention; and

FIG. 10 is a perspective view of a literature display system comprising another embodiment of the present invention.

### DETAILED DESCRIPTION

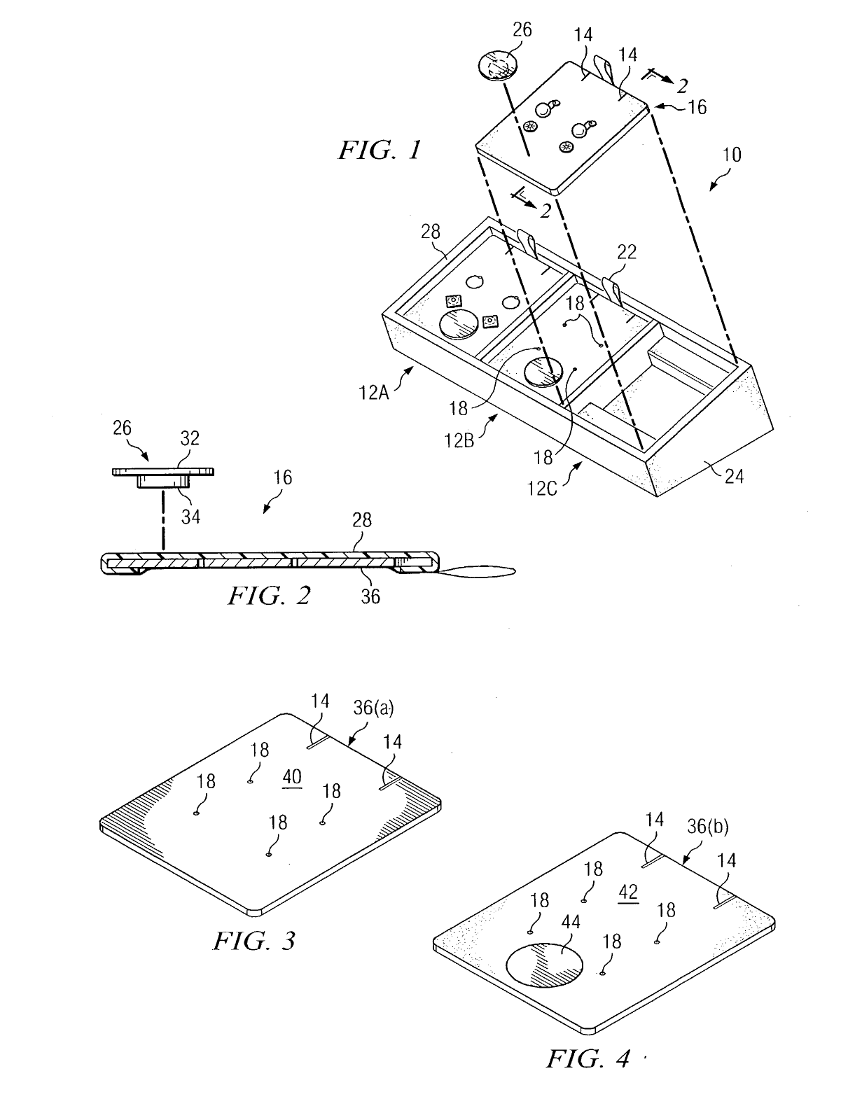

FIG. 1 is a perspective view of one embodiment of the present invention. Display device 10 includes a plurality of display positions 12A, 12B and 12C. Each display position includes necklace mounting slots 14 in a display mounting 16. The display mounting 16 serves as the primary display device for this embodiment. These necklace mounting slots allow insertion of the chain of a necklace. In practice, just enough chain is allowed on the front of display mounting 16 to allow the pendant of the necklace to hang in the center of display mounting 16. After the necklace (not shown) is placed in the necklace mounting slots 14, the display mounting 16 is inserted into its position. Each display mounting 16 includes a loop 22 that allows for easy removal of display mounting 16 from base 24.

Base 24 may be structured and buttressed in many ways known in the art to provide a solid base for positioning the display mounting 16. In addition, both the base 24 and the display mounting 16 are preferably covered in a soft but durable covering 28 to provide a elegant display. A preferred covering is a padded Vienna Leatherette. This covering is preferred because it is highly washable and durable while providing a soft elegant feel to the touch. While Vienna Leatherette may be included in a preferred embodiment of the invention, many other coverings may be suitably used. For example, suede leather, silk fabric and velvet fabric may be advantageously used. In addition, non-fabric finishes may be used, such as wood veneer and high quality plastic finishes. In a further alternative, base 24 and/or display mounting 16 may be formed of plastic using, for example, an injection molding process where the resulting finish is suitable for use in the display.

In addition to necklace mounting slots 14, display mounting 16 includes earring mounting holes 18. These holes allow for the display of stud type earrings for pierced ears. Using both necklace mounting slots 14 and earring mounting holes 18, a matching set of earrings and a necklace may be displayed in one display position. As shown in FIG. 1, the display mounting 16 for position 12C has earrings mounted at all four earring mounting holes 18. The display mounting 16 for position 12A includes earrings mounted in two of the earring mounting holes 18. Although the current embodiment shows the use of necklace mounting slots 14 and earring mounting holes 18 for the display of items, it is important to note that the invention is not limited to any particular configuration for the display of merchandise, but rather is directed to a structure and method for displaying tags in conjunction with the display of merchandise.

At each display position 12A, 12B and 12C, one or more magnetic tags 26 may be placed onto the surface of display. The tags serve as a secondary display device in this embodiment. As shown in FIG. 2, magnetic tag 26 consists of a display surface 32 mounted to a magnet 34. A desired message is printed on or applied to the top display surface 32. This provides desired messages, such as “Sale” or “Special Purchase”. In addition, the message may simply be the logo of the retailer or manufacturer of the product on display. In addition, the message may be a three dimensional design to provide a particularly elegant message.

The magnetic tag 26 is held to display mounting 16 by magnetic attraction. Display mounting 26 includes mounting substrate 36, which is covered with covering 28 as described earlier. Mounting substrate 36 may include a number of configurations. One configuration is shown in FIG. 3. Mounting substrate 36(a) consists of a solid plate 40 of steel, which is machined to include earring mounting holes 18 and necklace mounting slots 14. Preferably, plate 40 consists of stainless steel because of its durability and long term corrosion resistance. Because mounting substrate 36(a) consists of a ferrous metal, magnetic tag 26 will be held to the surface of display mounting 16.

Another embodiment of mounting substrate 36 is shown in FIG. 4. In this embodiment, mounting substrate 36(b) consists of main plate 42 and ferrous insert 44. Main plate 42 is preferably formed from a stiff material that is easy to manufacture and machine. Examples of such materials are wood, plastic and cardboard. Earring mounting holes 18 and necklace mounting slots 14 are machined into main plate 42 using known machining techniques. In an additional embodiment, main plate 42 is formed by injection molding of plastic. The mold used to form the main plate of this embodiment includes earring mounting holes 18 and necklace mounting slots 14. Therefore, a separate machining step to form earring mounting holes 18 and necklace mounting slots 14 is not necessary.

An opening is either formed or machined into main plate 42 for mounting ferrous insert 44. The opening is formed having the same shape and slightly smaller than ferrous insert 44. Ferrous insert 44 is pressed into the opening and is held in place by friction. Ferrous insert 44 is shown in FIG. 4 as a round insert, but may be any desired shape. Preferably, ferrous insert is composed of stainless steel. However, any material capable of magnetic attraction may be suitably used, even if the material is not technically an iron containing metal. A “ferrous” material or metal as it used in this specification only refers to materials that are capable of magnetic attraction and may or may not be metallic or iron containing.

The configuration of mounting substrate 36(b) is a preferred embodiment because it is inexpensive to fabricate relative to the embodiment of 36(a). In addition, the embodiment of 36(b) only allows placement of magnetic tags 26 in the selected spot where ferrous insert 44 is placed. The magnetic tag 26 will not adhere to other positions on the display mounting 16 because there is no material at those other positions that will produce a magnetic attractive force with magnet 34. This placement is selected so that the tag is centered and in an ideal viewing position, thus insuring a professional appearance, even if the sales associate is sloppy in placing the tag on the display device 10.

Of importance, although ferrous insert 44 is shown in the configuration of a dot or small circle, the scope of the invention is by no means limited to that configuration. Ferrous insert 44 may be square, oval, rectangular or any other shape. The specific configuration of ferrous insert 44 is only exemplary. In addition, this and other embodiments of the present invention in this application are configured with a ferrous element in the display and a magnet in the tag. The reverse of this configuration is also with the scope of the present invention and many be used in all of the described embodiments. For example, ferrous insert 44 may be magnetic and magnet 34 may be a ferrous material. Further, with if the ferrous insert 44 is replaced with a magnet, magnet 34 may be omitted if display surface 32 is formed using a ferrous material. In this case, the display surface will adhere directly to insert 44. In addition, the present invention is not limited to the used of magnetic attatraction as the force for holding magnetic tag 26 in place. For example, insert 44 may be replace with a Velcro layer (either the hooks or loops layer). In this case, magnet 34 would be replaced with a mating Velcro layer. Many methods for securing magnetic tags 26 will become apparent to those skilled in the art in light of the teachings of this written description.

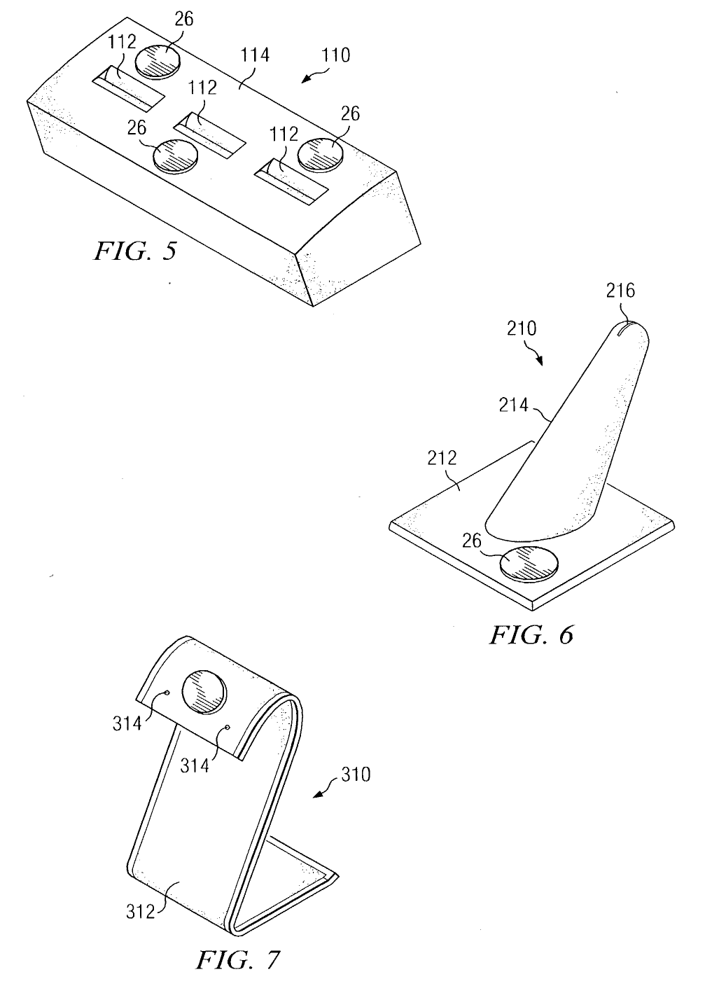

FIG. 5 shows another embodiment of the present invention. Display device 110 includes three padded slots 112. Cloth covered foam is inserted on opposing sides of the padded slots 112. A finger ring (not shown) can they be displayed in display device 110 by inserting the finger ring into a padded slot 112. The finger ring is held firmly between the cloth covered foam. At least the top surface 114 of the display device 110 includes a ferrous based substrate (not shown), such as stainless steel. The substrate may be entirely ferrous, except for the openings for padded slots 112, or only selected portions of the substrate may be ferrous, such as positioned dots, rectangles, etc. Preferably, top surface 114 is fabricated using Vienna Leatherette covering a ferrous based substrate as in display mounting 16 of the embodiment of FIG. 1. This allows for the placement of magnetic tags 26 as shown in FIG. 5. Alternatively, the substrate of surface 114 may be a generally a non-ferrous material with ferrous inserts (not shown) similar to those used with substrate 36(b) of FIG. 4.

FIG. 6 shows another embodiment of the present invention. Display device 210 includes a base 212. Extending from the base 212 is a display projection 214. At the end of projection 214, a slot 216 is cut. A finger ring (not shown) can they be displayed in display device 210 sliding the finger ring over projection 214. At least the base 212 of the display device 210 includes a ferrous based substrate (not shown), such as stainless steel. Preferably, base 212 is fabricated using Vienna Leatherette covering a ferrous based substrate as similar to substrate 36(a) as used in display mounting 16 of the embodiment of FIG. 1. This allows for the placement of magnetic tag 26 as shown in FIG. 6. Alternatively, the substrate of base 212 may be a generally a non-ferrous material with ferrous inserts (not shown) similar to those used with substrate 36(b) of FIG. 4. As another alternative, display projection 214 may consist of a structural substrate (not shown) covered with a flexible material, such as Vienna Leatherette. The structural substrate of display projection 214 may be entirely or partially formed from a ferrous material. This would allow placement of a magnetic tag 26 on display projection 214.

FIG. 7 shows another embodiment of the present invention. Display device 310 consists of a substrate (not shown) consisting of a flat sheet that is formed into a shape having a side profile resembling the number 2. The base is flat so that display device 310 will stand on a counter. The substrate is covered in a flexible covering 312. One suitable covering is Vienna Leatherette. Holes 314 are formed in the display device 310 and allow for the display of earrings and the like. The holes 314 may be expanded for the display of cuff links or other items that require a larger hole. The substrate of display device 310 includes a ferrous based material, such as stainless steel. Preferably, the substrate is entirely formed of the ferrous based material, similarly to the display mounting 16 of the embodiment of FIG. 1. This allows for the placement of magnetic tags 26 as shown in FIG. 7. Alternatively, the substrate may be a generally a non-ferrous material with ferrous inserts (not shown) similar to those used with substrate 36(b) of FIG. 4.

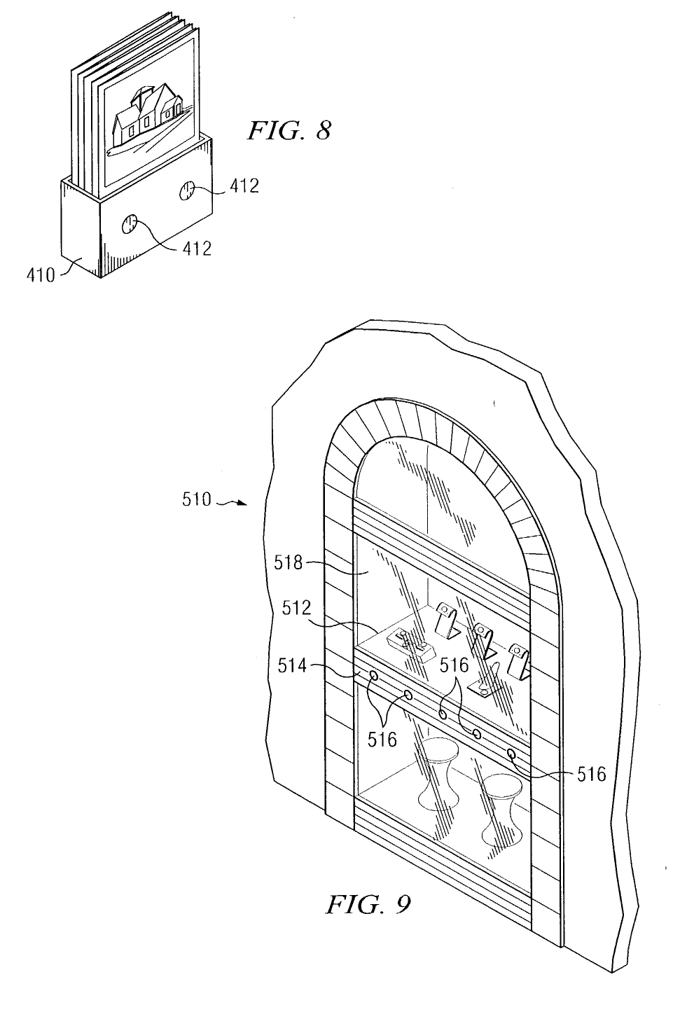

FIG. 8 shows another embodiment of the present invention comprising a literature display stand having replaceable tags. Literature holder 410 is configured to hold brochures and the like on a counter top. The particular configuration of the literature holder is exemplary. Inserts 412 are ferrous inserts and are positioned to allow a secondary display provided by magnetic tags (not shown) on the front of the literature holder 410. The positioning of inserts 412 is exemplary. Any position suitable for a secondary display may be used.

FIG. 9 shows another embodiment of th present invention comprising a display case having replaceable tags. Display window 510 includes a display shelf 512, which may include permanent or removable display items as the primary display. As shown in FIG. 9, the front edge of display shelf 512 includes display shelf trim 514. Display shelf trim 514 is shown in FIG. 9 as coplanar with glass 518. In an alternative embodiment, glass 518 may cover the entire opening in display window 510 and display shelf trim would then be behind glass 518. Inserted into the surface of display shelf trim 514 are ferrous inserts 516. The ferrous inserts 516 provide for a place for magnetic tags (not shown) to be attached to the front of the display shelf 512 to provide a secondary display. The ferrous inserts may be in any suitable position for a secondary display. Their position in a display shelf trim 514 is only exemplary. As with the other embodiments, inserts 516 may be magnetic, in which case ferrous tags (not shown) would be used.

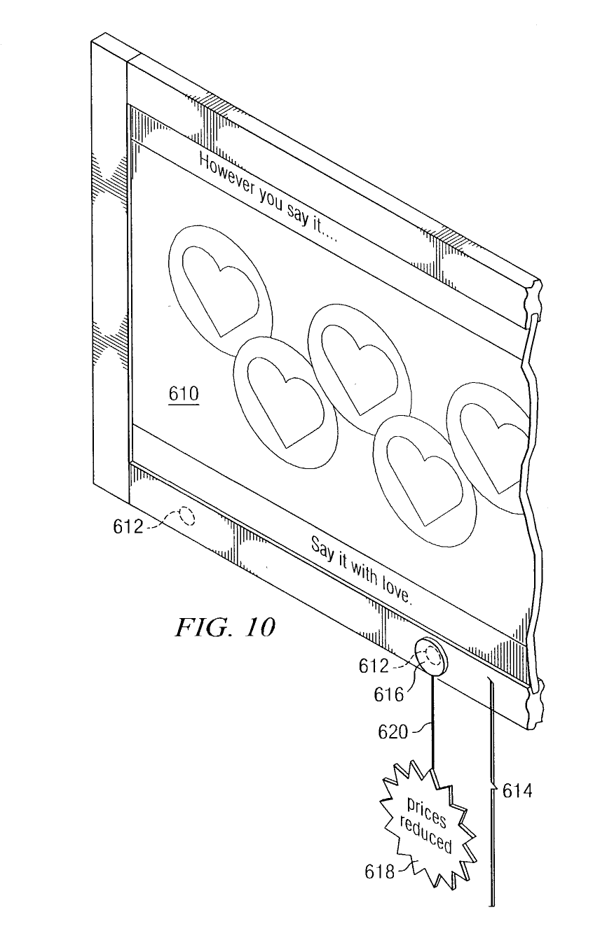

FIG. 10 shows another embodiment of the present invention comprising a sign having replaceable tags. In this embodiment, the primary display is a sign 610. Embedded in to the face of sign 610 are steel inserts 612. Of course, other ferrous materials may be substituted for steel and remain with in the scope of the present invention. Magnetic attachments 614 may be removably attached to sign 610. The magnetic attachments each comprise a magnet 616, a secondary display 618 and connector 620 connecting magnet 616 and secondary display 618. Preferably, string 620 is a clear string formed with a nearly invisible material, such as nylon fishing line. This provides the illusion that the secondary displays 618 are floating. The magnetic attachments are attached to sign 610 by magnetic attraction between magnets 616 and steel inserts 612. In FIG. 10, steel inserts 612 are positioned on the face of sign 610. However, other positions may be used. For example, steel inserts 612 may be positioned on the bottom edge or the back of sign 610. These positions have the advantage that the magnets 616 are less visible in these positions as opposed to the positions on the front of sign 610, thus enhancing the impression that secondary display 618 is floating. As with other embodiments, steel inserts 610 may be substituted with a magnetic material and magnets 616 would then be substituted with a ferrous material. Preferably, magnets 616 are removably attached to string 620 using a compression clip (not shown), which allows magnets 616 to be reused with other secondary displays.

Although the present invention has been described with regard to several embodiments, those embodiments are not to be construed as limiting the scope of the invention. Many embodiments of the invention will become apparent to those skilled in the art in light of the teachings of this written description. For example, the described embodiments are for the display of jewelry. However, the scope of the invention is not limited to the display of jewelry. Any item that is capable of being held in a mounting may be advantageously used with an embodiment of the present invention that is adapted for that item. For example, the displays may be used to display eyeglasses, clothing, electronic goods, etc. The only limitation of the scope of the invention are the claims appended hereto and equivalents thereof.

We claim,

1. A system for display comprising:
a primary display including a ferrous component; and
a tag, the tag having a display surface for display of a desired message and having a magnet attached thereto, the magnet providing an attractive force to the ferrous component when the tag is placed on the mounting.

2. A system for display as in claim 1 wherein the primary display is a mounting, the mounting being adapted for the display of an item.

3. A system for display as in claim 2 wherein the mounting is adapted for the display of jewelry.

4. A system for display as in claim 2 wherein the mounting is adapted for the display of ear rings.

5. A system for display as in claim 2 wherein the mounting is adapted for the display of a necklace.

6. A system for display as in claim 2 wherein the mounting is adapted for the display of finger rings.

7. A system for display as in claim 1 wherein the primary display is a sign.

8. A system for display as in claim 1 wherein the ferrous component is an iron containing metal.

9. A system for display as in claim 8 wherein the iron containing metal is stainless steel.

10. A system for display as in claim 1 wherein the ferrous component is coextensive with the mounting.

11. A system for display as in claim 1 wherein the ferrous component is a dot inserted into a substrate of the primary display.

12. A system for display as in claim 1 wherein the primary display is a display window.

13. A system for display as in claim 1 wherein the primary display is a literature holder.

14. A display device comprising:
a surface of the display device including a ferrous component;
a mounting, the mounting being adapted for the display of an item; and
a tag, the tag having a display surface for display of a desired message and having a magnet attached thereto, the magnet providing an attractive force to the ferrous component when the tag is placed on the surface.

15. A display device as in claim 14 wherein the mounting is adapted for the display of jewelry.

16. A display device as in claim 14 wherein the mounting is adapted for the display of ear rings.

17. A display device as in claim 14 wherein the mounting is adapted for the display of a necklace.

18. A display device as in claim 14 wherein the mounting is adapted for the display of finger rings.

19. A display device as in claim 14 wherein the ferrous component is an iron containing metal.

20. A display device as in claim 19 wherein the iron containing metal is stainless steel.

21. A display device as in claim 14 wherein the ferrous component is coextensive with the surface.

22. A display device as in claim 14 wherein the ferrous component is a dot inserted into a substrate of the surface.

23. A method for display of an item comprising the steps of:
providing a mounting including a magnetic component, the mounting being adapted for the display of the item; and
providing a tag, the tag having a display surface for display of a desired message and having a ferrous component, the ferrous component providing an attractive force to the magnetic component when the tag is placed on the mounting.

24. A method for display of an item as in claim 23 wherein the item is jewelry.

25. A method for display of an item as in claim 23 wherein the item is ear rings.

26. A method for display of an item as in claim 23 wherein the item is a necklace.

27. A method for display of an item as in claim 23 wherein the item is a finger ring.

28. A method for display of an item as in claim 23 wherein the ferrous component is an iron containing metal.

29. A method for display of an item as in claim 28 wherein the iron containing metal is stainless steel.

30. A method for display of an item as in claim 23 wherein the ferrous component is coextensive with the tag.

31. A method for display of an item as in claim 23 wherein the magnetic component is a dot inserted into a substrate of the mounting.

32. A system for display comprising:
a primary display including a magnetic component; and
a tag, the tag having a display surface for display of a desired message and having a ferrous component attached thereto, the ferrous component providing an attractive force to the magnetic component when the tag is placed on the mounting.

33. A system for display as in claim 32 wherein the primary display is a mounting, the mounting being adapted for the display of an item.

34. A system for display as in claim 33 wherein the mounting is adapted for the display of jewelry.

35. A system for display as in claim 33 wherein the mounting is adapted for the display of ear rings.

36. A system for display as in claim 33 wherein the mounting is adapted for the display of a necklace.

37. A system for display as in claim 33 wherein the mounting is adapted for the display of finger rings.

38. A system for display as in claim 32 wherein the primary display is a sign.

39. A system for display as in claim 32 wherein the ferrous component is an iron containing metal.

40. A system for display as in claim 39 wherein the iron containing metal is stainless steel.

41. A system for display as in claim 32 wherein the ferrous component is coextensive with-the tag.

42. A system for display as in claim 32 wherein the magnetic component is a dot inserted into a substrate of the primary display.

43. A display device comprising:
a surface of the display device including a ferrous component;
a mounting, the mounting being adapted for the display of an item; and
a tag, the tag having a display surface for display of a desired message and having a magnet attached thereto, the magnet providing an attractive force to the ferrous component when the tag is placed on the surface.

44. A display device as in claim 43 wherein the mounting is adapted for the display of jewelry.

45. A display device as in claim 43 wherein the mounting is adapted for the display of ear rings.

46. A display device as in claim 43 wherein the mounting is adapted for the display of a necklace.

47. A display device as in claim 43 wherein the mounting is adapted for the display of finger rings.

48. A display device as in claim 43 wherein the ferrous component is an iron containing metal.

49. A display device as in claim 48 wherein the iron containing metal is stainless steel.

50. A display device as in claim 43 wherein the ferrous component is coextensive with the surface.

51. A display device as in claim 43 wherein the ferrous component is a dot inserted into a substrate of the surface.

52. A system for display as in claim 43 wherein the primary display is a display window.

53. A system for display as in claim 43 wherein the primary display is a literature holder.

54. A method for display of an item comprising the steps of:
providing a mounting including a ferrous component, the mounting being adapted for the display of the item; and
providing a tag, the tag having a display surface for display of a desired message and having a magnet attached thereto, the magnet providing an attractive force to the ferrous component when the tag is placed on the mounting.

55. A method for display of an item as in claim 54 wherein the item is jewelry.

56. A method for display of an item as in claim 54 wherein the item is ear rings.

57. A method for display of an item as in claim 54 wherein the item is a necklace.

58. A method for display of an item as in claim 54 wherein the item is a finger ring.

59. A method for display of an item as in claim 54 wherein the ferrous component is an iron containing metal.

60. A method for display of an item as in claim 59 wherein the iron containing metal is stainless steel.

61. A method for display of an item as in claim 54 wherein the ferrous component is coextensive with the mounting.

62. A method for display of an item as in claim 54 wherein the ferrous component is a dot inserted into a substrate of the mounting.

63. A method for display of an item comprising the steps of:
providing a display device having a surface device including a ferrous component;
providing a mounting, the mounting being adapted for mounting of the item thereon; and
providing a tag, the tag having a display surface for display of a desired message and having a magnet attached thereto, the magnet providing an attractive force to the ferrous component when the tag is placed on the surface.

64. A method for display of an item as in claim 63 wherein the item is jewelry.

65. A method for display of an item as in claim 63 wherein the item is ear rings.

66. A method for display of an item as in claim 63 wherein the item is a necklace.

67. A method for display of an item as in claim 63 wherein the item is a finger ring.

68. A method for display of an item as in claim 63 wherein the ferrous component is an iron containing metal.

69. A method for display of an item as in claim 68 wherein the iron containing metal is stainless steel.

70. A method for display of an item as in claim 63 wherein the ferrous component is coextensive with the surface.

71. A method for display of an item as in claim 63 wherein the ferrous component is a dot inserted into a substrate of the surface.

72. A system for display comprising:
a primary display including a first velcro component; and
a tag, the tag having a display surface for display of a desired message and having a second velcro component attached thereto, the second velcro component removably binding to the first velcro component when the tag is placed on the mounting.

73. A system for display as in claim 72 wherein the primary display is a mounting, the mounting being adapted for the display of an item.

74. A system for display as in claim 73 wherein the mounting is adapted for the display of jewelry.

75. A system for display as in claim 73 wherein the mounting is adapted for the display of ear rings.

76. A system for display as in claim 73 wherein the mounting is adapted for the display of a necklace.

77. A system for display as in claim 73 wherein the mounting is adapted for the display of finger rings.

78. A system for display as in claim 72 wherein the primary display is a sign.

79. A system for display as in claim 72 wherein the first velcro component is a dot inserted into a substrate of the primary display.

80. A system for display as in claim 72 wherein the primary display is a display window.

81. A system for display as in claim 72 wherein the primary display is a literature holder.
